(19) United States
(12) Patent Application Publication
(10) Pub. No.: US 2013/0100140 A1
(43) Pub. Date: Apr. 25, 2013

(54) HUMAN BODY AND FACIAL ANIMATION SYSTEMS WITH 3D CAMERA AND METHOD THEREOF

(71) Applicant: CyWee Group Limited, Tortola (VG)

(72) Inventors: Zhou Ye, Foster City, CA (US); Ying-Ko Lu, Taoyuan County (TW); Sheng-Wen Jeng, Tainan City (TW)

(73) Assignee: CYWEE GROUP LIMITED, Tortola (VG)

(21) Appl. No.: 13/659,925

(22) Filed: Oct. 25, 2012

Related U.S. Application Data
(60) Provisional application No. 61/550,928, filed on Oct. 25, 2011.

(51) Int. Cl. G06T 13/20

(52) U.S. Cl. CPC G06T 13/20
USPC 345/473

(57) ABSTRACT

An animation system integrating face and body tracking for puppet and avatar animation by using a 3D camera is provided. The 3D camera human body and facial animation system includes a 3D camera having an image sensor and a depth sensor with same fixed focal length and image resolution, equal FOV and aligned image center. The system software of the animation system provides on-line tracking and off-line learning functions. An algorithm of object detection for the on-line tracking function includes detecting and assessing a distance of an object; depending upon the distance of the object, the object can be identified as a face, body, or face/hand so as to perform face tracking, body detection, or ‘face and hand gesture’ detection procedures. The animation system can also have zoom lens which includes an image sensor with an adjustable focal length f′ and a depth sensor with a fixed focal length f.

### FIELD OF THE INVENTION

The present invention relates to animation systems, especially to an avatar or a puppet animation system driven by facial expression or body posture with 3D camera.

### BACKGROUND OF THE INVENTION

In recent decades, avatars (especially faces) animated by facial expression extracted from real-time input image (captured with web camera) have been developed and published in many technical literatures by using various methods. The core technologies for facial feature extraction used are so called ‘deformable shape extraction’ methods (for example, snake, AAM, CLM . . . , etc.) which track real-time facial expressions to drive ‘avatars’ to act out or mimic the same expression. This type of facial feature extraction work is based on data from 2D images and is easily suffered from environmental or background noises (even in good lighting condition) to distort the extracted facial shape (especially the face border), which may make the extracted facial image result become a peculiar or unusual looking animated ‘avatar’ facial image being displayed on the screen. FIGS. 1a˜1b show an example illustrating this case of extracted facial image result.

Recently, 3D camera has become a reality for commercial market adoption. Although 3D camera can capture a depth map and a color 2D image at one snap shot, the current conventional developed usages are mostly focused on the ‘3D’ aspect of the depth map to extract the necessary information. For example, the skeleton of a body (including the joint points of a hand, a leg, etc.) is extracted to drive a full body puppet to be dancing or striking a ball using a bat in a sport gaming animation system.

Therefore, the problems described in FIGS. 1a˜1b remains to be solved, that is the conventional 3D camera and animation system are not able to successfully provide full body puppet animation while also having simultaneous high quality image details for the face region of the animated avatar. Thus, there is room for improvement in the field of art.

### SUMMARY OF INVENTION

The present invention relates generally to an animation system integrating face and body tracking for a head only or a full body puppet animation by full use the capability and benefits of a 3D camera. With integration of the 3D data in the depth map to confine a head region of a person as captured in the 2D image together with the rest of the animation system and method of the present invention, the conventional problems as shown in FIGS. 1a˜1b can be thereby avoided.

One aspect of the present invention is directed to a 3D camera human body and facial animation system which includes a 3D camera having an image sensor and a depth sensor with a same fixed focal length and image resolution, an equal field of view (FOV) and an aligned image center. A system software for the 3D camera human body and facial animation system includes a user GUI, an animation module and a tracking module. The system software of the animation system provides the following functions: on-line tracking via the User GUI and command process, and tracking and animation integration; and off-line learning via building an avatar (face, character) model, and tracking parameters learning.

Another aspect of the present invention is directed to an algorithm of object detection for the on-line tracking function of the aforementioned system software for the 3D camera human body and facial animation system which includes the following steps: (1) detecting and assessing a distance of an object in a depth map from a 3D camera; (2) if the object is located near a predefined distance (see FIG. 2) marked “Distance 1” as measured from the 3D camera and is accompanying a very deep background scene, meaning that the background scene comprising scenery occupying regions that are located at a significantly large or lengthy distance away from 3D camera, the object is then recognized and identified as being a face, and a face tracking procedure (for obtaining a face region) is performed; (3) if the object is located near a predefined distance (see FIG. 2) marked “Distance 2” and is recognized to resemble a whole body of a person, the object is then identified as a body, and a body tracking procedure (for obtaining a body region) is performed; and (4) if the object is detected to be located in between Distance 1 and Distance 2, a ‘face and hand gesture’ detection procedure (for obtaining the face region and a hand region) is performed.

Another aspect of the present invention is directed to another embodiment of a human body and facial animation system with one or more 3D cameras having one or more zoom lens which includes an image sensor with an adjustable focal length f′ and a depth sensor with a fixed focal length f.

Another aspect of the present invention is directed to yet another embodiment of a human body and facial animation system with a plurality of 3D cameras, which includes an image sensor with a fixed focal length f′ and another image sensor with a fixed focal length f. The two different focal lengths f and f′ are predesigned and configured for operating capability at an extended large distance for full body and detailed facial expression image capturing.

These and other features of the present invention will become readily apparent upon further review of the following specification and drawings.

### BRIEF DESCRIPTION OF THE DRAWINGS

The components in the drawings are not necessarily drawn to scale, the emphasis instead placed upon clearly illustrating the principles of the present invention. Moreover, in the drawings, like reference numerals designate corresponding parts throughout the several views.

FIGS. 1a˜1b show an example of a conventional 2D image face tracking algorithm having distorted facial features when being extracted from the facial image result of a person.

FIGS. 2a˜2b show an embodiment of a 3D camera animation system with a fixed focal length according to the present invention.

FIGS. 3a˜3b show an example of facial animation according to an embodiment of the present invention.

FIGS. 4a˜4b shows an example of body animation according to an embodiment of the present invention.

FIG. 5 shows a flowchart of an algorithm for object detection for the on-line tracking function for the 3D camera human body and facial animation system according to an embodiment of the present invention.

FIG. 6 shows image formation with different focal lengths obtained via the zoom lens 3D camera.

FIG. 7 shows an image formation equation for zoomed focal length (f′) and resized image (I′).

FIGS. 8-11 show the images captured from the image sensor, the depth maps captured from the depth sensor and the corresponding image of the animated avatar.

FIG. 12 shows the 3D human body and facial animation system with a 3D camera having two different focal lengths.

FIG. 13 shows a depth map of an object located at a far distance at focal length f according to a simulation example based on conventional 3D avatar animation technique.

FIG. 14a shows a zoomed face image of a person with the image sensor configured at focal length f′ according to a simulation for another embodiment of the present invention.

FIG. 14b shows a depth map of an avatar being overlaid on the depth map of FIG. 14a according to simulation for yet another embodiment of the present invention.

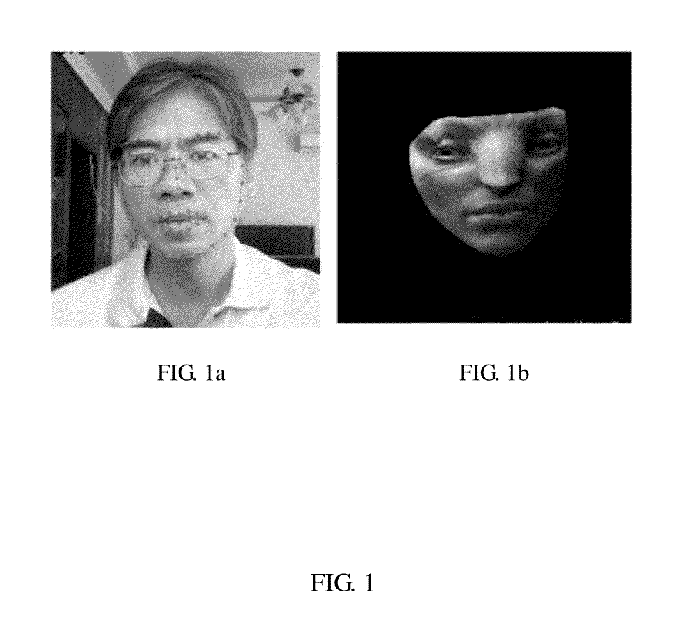

### DETAILED DESCRIPTION OF THE INVENTION

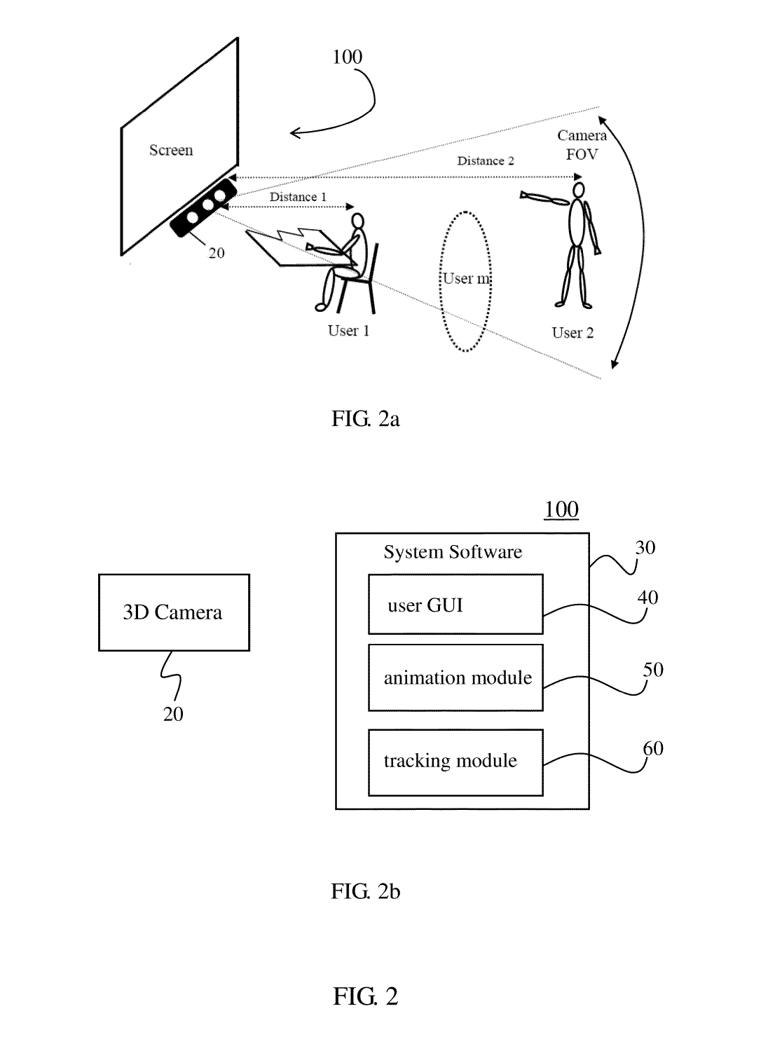

One embodiment of a 3D camera animation system 100 with a fixed focal length according to the present invention is shown in FIGS. 2a˜2b. Referring to FIGS. 2a˜2b, the 3D camera animation system 100 include a 3D camera 20 and a system software 30. The 3D camera 20 includes an image sensor (not shown) and a depth sensor (not shown) with a same fixed focal length, a same image resolution, an equal field of view (FOV) and an aligned image center. The system software 30 includes a user GUI 40, an animation module 50 and a tracking module 60. The system software 30 is configured to provide the following functions:

On-line tracking via the following:

(1) the user GUI 40 and a command process, and

(2) tracking and animation integration.

Off-line learning via the following:

(1) an avatar (face, character) model building, and

(2) tracking parameters learning.

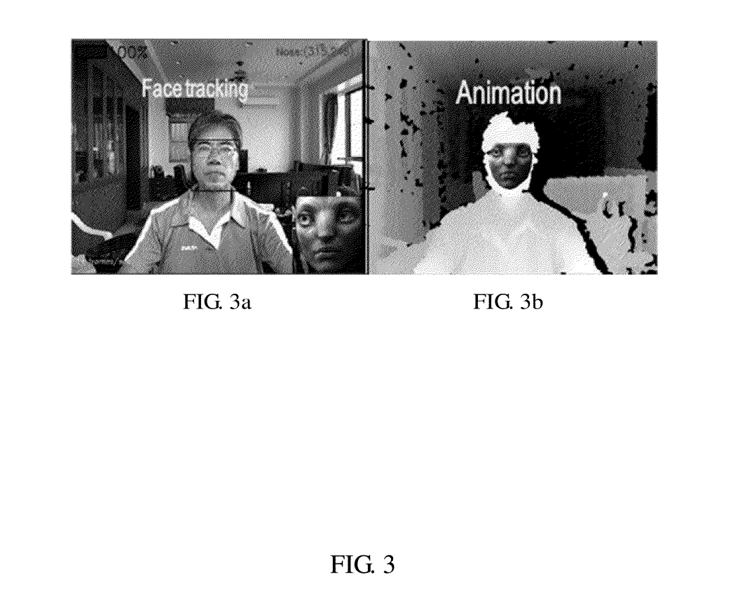

FIGS. 3a˜3b shows an example of facial animation according to an embodiment of the present invention. In FIG. 3a, face tracking is applied on an inputted 2D image captured with the 3D camera 20. In FIG. 3b, the extracted face shape is used to drive a Na'vi movie character face image from the movie called Avatar to act upon the same facial expressions and to be displayed on a screen (to be overlapped on a depth map which is captured with the same 3D camera 20).

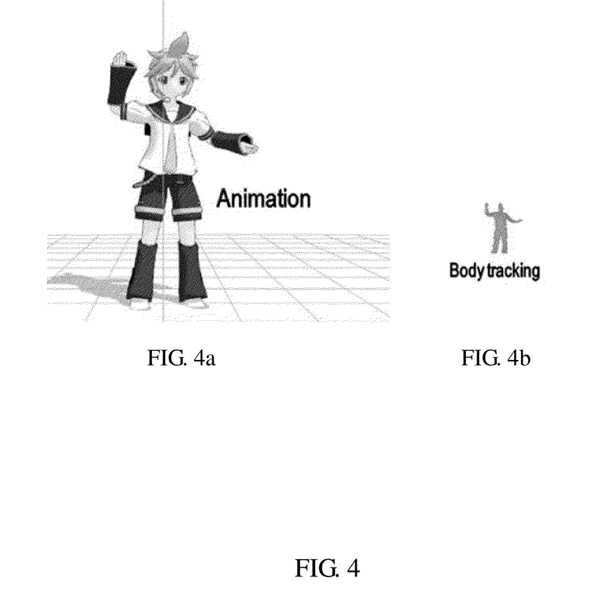

FIGS. 4a˜4b show an example of body animation according to an embodiment of the present invention. Referring to FIG. 4a, an animated puppet with a same posture as that of an extracted body is shown. The extracted body as obtained from the depth map of the 3D camera 20 is shown in FIG. 4b.

Referring to FIGS. 2a˜2b, 3a˜3b, 4a˜4b, the 3D camera animation system performs various animation steps at a plurality of difference distances, for example:

Animation Step (a): At a Distance 1 of 60 cm˜100 cm as measured from the 3D camera to a User 1, a facial animation on the User 1 is performed.

Animation Step (b): At a Distance 2 of 200 cm˜300 cm as measured from the 3D camera to a User 2, a body animation on the User 2 is performed.

Animation Step (c): At another Distance m located between Distance 1 and Distance 2, a facial or hand gesture animation is performed on a User m.

An algorithm using data from the depth map can calculate a target object distance, such as, the Distance 1 for User 1, the Distance 2 for user 2, or the another distance m for User m, and automatically determine which of the animation steps (a), (b), and (c) mentioned above should be selected for usage.

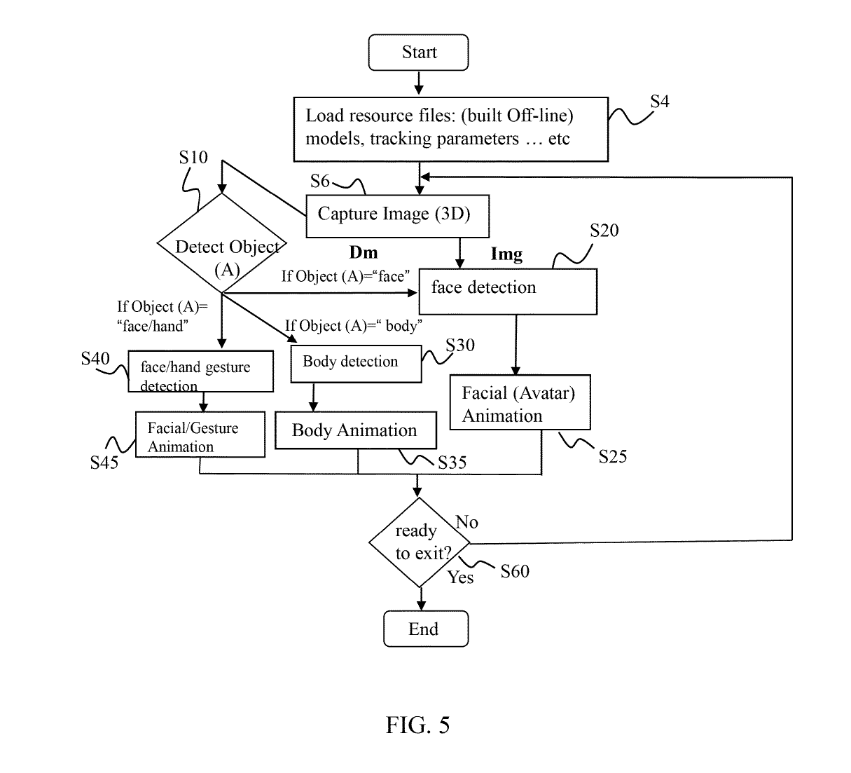

FIG. 5 shows a flowchart of an algorithm for object detection for the on-line tracking function for the 3D camera human body and facial animation system according to the embodiment of the present invention. The aforementioned object detection algorithm includes the following steps:

A plurality of resource files that are built during off-line learning via an avatar (face, character) model building, and tracking parameters learning are loaded in step (S4).

One color image (Img) and one depth map (Dm) are respectively captured by the image sensor and the depth sensor of the 3D camera of the 3D camera human body and facial animation system in step (S6).

One object is detected in a depth map captured by a 3D camera, and a distance of the object from a 3D camera to the object is determined in step (S10).

If the distance from a 3D camera to the object is assessed to be at about Distance 1 and is accompanying and corresponding to a very deep background scene, the object is then recognized and identified as a face, and a face tracking procedure is performed in step (S20), so as to obtain a face shape to provide for facial animation for the avatar in step (S25).

If the distance from the 3D camera to the object is assessed to at about Distance 2 and that the object is assessed to resemble a person (human being), the object is then considered to be recognized and identified as a body, and a body tracking procedure is performed in step (S30), so as to obtain the body shape for the body animation of the avatar in the step (S35).

If the distance from the 3D camera to the object is assessed to at about between Distance 1 and Distance 2, a face and hand gesture detection procedure is then performed (S40), so as to obtain both the face shape and the hand shape features for facial/gesture animation of the avatar in the step (S45).

Upon successive iterations of the object detection algorithm for the on-line tracking function for the 3D camera human body and facial animation system, a user can choose to terminate the algorithm based upon personal preference and needs in the step (S60).

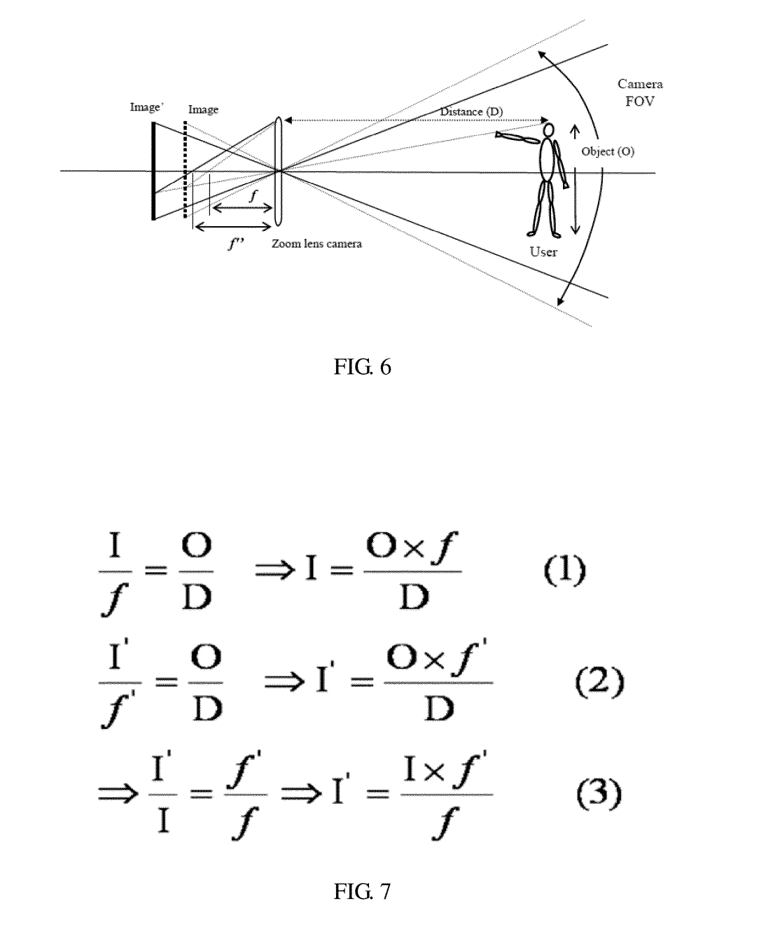

Moreover, according to another embodiment of a 3D camera human body and facial animation system, the 3D animation system includes a zoom lens 3D camera. The zoom lens 3D camera includes an image sensor with an adjustable focal length and a depth sensor with a fixed focal length. A strategy for maintaining a distance (D) of the object (O) to be unchanged or constant located at a far distance away from the zoom lens 3D camera for obtaining a combined simultaneous full body and detailed face tracking is achieved in the another embodiment of the present invention. Referring to FIG. 6, in this embodiment, image formation with different focal lengths obtained via the zoom lens 3D camera is shown. When the object is found to be located at a far distance (i.e., Distance 2 in FIG. 2a), a combined image comprising of facial image details as well as the full body posture is derived and produced. The issues caused by the conventional 3D camera having the fixed focal length as shown in FIG. 2a is that the face shown is visibly too small, and a significant amount of the feature details for the face region are lost when detecting the facial shape at the extended far reaching distance. To overcome the aforementioned issues, this embodiment of the present invention is configured with a 3D camera having a zoom lens (for imaging only) to zoom in on the object to capture significant amount of detailed face feature data (facial image details). To maintain the Distance (D) of the object (O) to remain unchanged and to have the face feature details as shown in FIG. 6, an image formation equation for zoomed focal length (f) and resized image (I′) is applied as shown in FIG. 7, where I represents the face size at a focal length f, and I′ represents the face size at a focal length f′ which becomes large enough for performing face tracking.

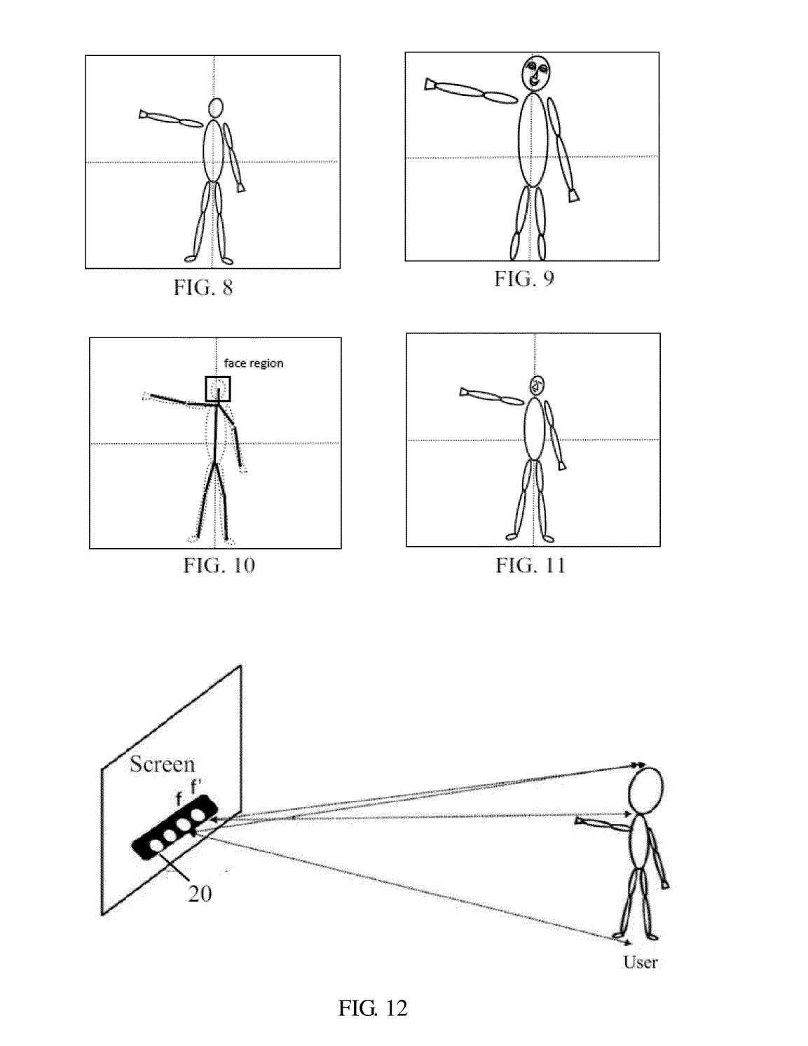

FIGS. 8-11 show the images captured from the image sensor, the depth map captured from the depth sensor and the corresponding image of the animated avatar. Incorporated with FIGS. 8-11, a method for providing avatar or puppet animation is provided. The method for providing avatar or puppet animation includes the following steps:
(a) Assume that an image resolution, an image center and a FOV are aligned in the image and depth sensors.
(b) At a distance D (for example, the Distance 2 in FIG. 2a) with an initial focal length f, the image sensor and the depth sensor can both detect and capture the full body image, but the face portion of such full body image is visibly too small for facial extraction by the image sensor (referring to FIG. 8).
(c) The focal length of the image sensor is then adjusted to f′, the depth map still captures the full body region while the focal length is kept at f as shown in FIG. 10, but the face region is enlarged to perform facial detail extraction in the image shown in FIG. 9.
(d) The body region and the face region are then extracted in the depth map shown in FIG. 10.
(e) The face region area extracted from the depth map is being cut out, so as to be replaced by the face region captured in the image sensor (FIG. 8) at f comprising of higher image details, and the face region is then enlarged in size, and by using the equations in FIG. 7, the facial image details are enlarged to form a part of the full body image at f′ as shown in FIG. 9. In other words, the facial image details found in the full body image at f′ shown in FIG. 9 is extracted from the image data obtained within the mapped face region captured by the image sensor. FIG. 11 shows the animated avatar with the full body and the higher image details face region at focal length f. Here, the animated avatar having a combined full body and higher image details face region is provided for animation.

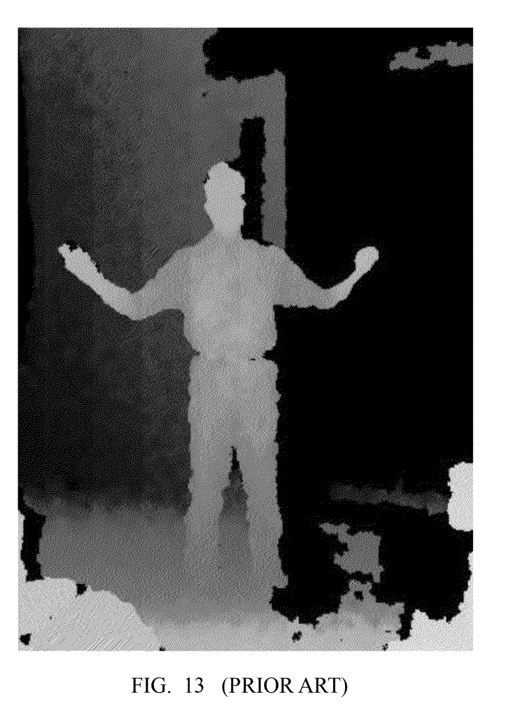

According to yet another embodiment of the present invention, a 3D human body and facial animation system includes a 3D camera that has two images sensors, in which each image sensor has a different fixed focal length, namely, one image sensor has a fixed focal length f, and the other image sensor has a fixed focal length f′, is provided. Referring to FIG. 12, the 3D human body and facial animation system with 3D camera can perform effectively at an extended distance between the 3D camera and the user (relatively long distance, i.e. Distance 2 in FIG. 2a). The 3D camera in this embodiment includes two image sensors having individual fixed focal lengths. Adopting the method for providing avatar or puppet animation described in FIGS. 8-11 and using the 3D camera outfitted with the two image sensors, the face region is captured and extracted by the image sensor having the fixed focal length f′, while the body region is captured and extracted by the image sensor having the fixed focal length f. Therefore, an avatar having full body and high image details face region can then be configured for performing animation.

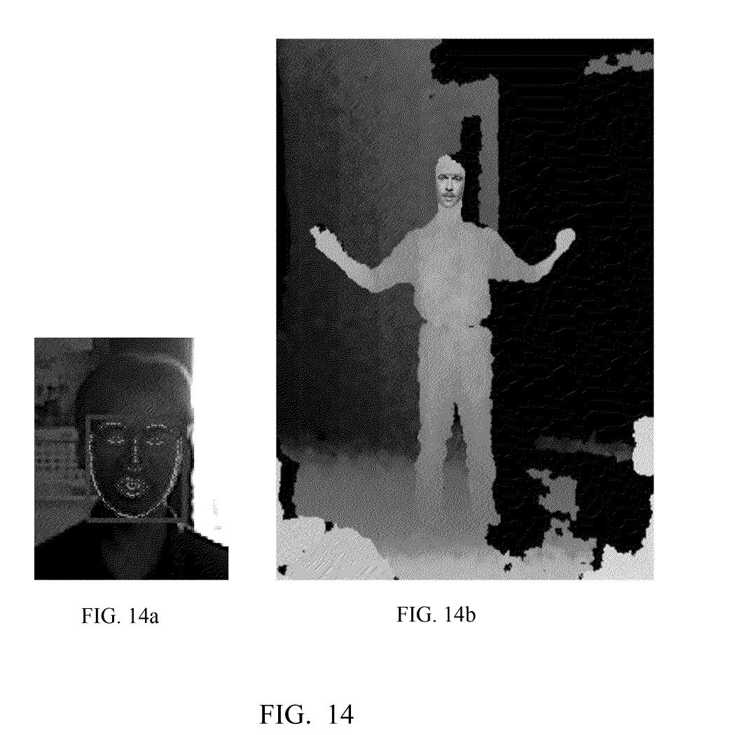

The advantages and benefits of the 3D camera human body and facial animation system, the system software thereof, and the algorithm of object detection for the on-line tracking function of the aforementioned system software for the 3D camera human body and facial animation system of the embodiments of the present invention can be seen by means of a simulation example shown in FIGS. 14a˜14b, in comparison to a comparative simulation example shown in FIG. 13. FIG. 13 shows a depth map of a person located at a far distance at focal length f according to a simulation example based on conventional 3D avatar animation technique. One can see that only the full body contour of the person is visible as found by using this conventional method for 3D avatar animation. On the other hand, FIG. 14a shows a zoomed face image of a person with the image sensor configured at the focal length f′ according to the simulation result of another embodiment of the present invention. In addition, according to this simulation result for yet another embodiment, FIG. 14b shows a depth map of an avatar with the overlapping zoomed face image (of improved image details obtained as shown in FIG. 14a) being fully overlaid or superimposed on the depth map of the person, to thereby achieve an improved 3D animation effect over conventional 3D animation techniques.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A human body and facial animation system with 3D camera, comprising:
a 3D camera, comprising an image sensor and a depth sensor; and
a system software, comprising a user GUI, an animation module and a tracking module;
wherein the image sensor and the depth sensor each having a focal length, an image resolution, an field of view (FOV), and an image center; and the system software providing on-line tracking and off-line learning functions.

2. The human body and facial animation system with 3D camera of claim 1, wherein the image sensor and the depth sensor both having a same fixed focal length, a same image resolution, an equal field of view (FOV) and an aligned image center.

3. The human body and facial animation system with 3D camera of claim 2, wherein the system software providing on-line tracking via the user GUI and a command process, and tracking and animation integration; and the system software providing off-line learning via building an avatar model, and tracking parameters learning.

4. The human body and facial animation system with 3D camera of claim 1, wherein the system software providing on-line tracking via the user GUI and a command process, and tracking and animation integration; and the system software providing off-line learning via building an avatar model, and tracking parameters learning.

5. The human body and facial animation system of claim 1, wherein the 3D camera is a zoom lens 3D camera and comprising:
an image sensor, having an adjustable focal length; and
a depth sensor, having a fixed focal length;
wherein the human body and facial animation system maintaining a distance (D) of one object (O) to be unchanged locating at a far distance away from the zoom lens 3D camera for obtaining a combined simultaneous full body and detailed face tracking.

6. The human body and facial animation system of claim 5, wherein the Distance (D) of the object (O) to remain unchanged and a face size with respect to a focal length is defined by an image formation equation (3) for a zoomed focal length (f′) and a resized image (I′) as follow:
$$\begin{matrix}\frac{I}{f} = \frac{O}{D} ⇒ I = \frac{O \times f}{D} & ( 1 ) \\ \frac{{I}^{′}}{{f}^{′}} = \frac{O}{D} ⇒ {I}^{′} = \frac{O \times {f}^{′}}{D} & ( 2 ) \\ ⇒ \frac{{I}^{′}}{I} = \frac{{f}^{′}}{f} ⇒ {I}^{′} = \frac{I \times {f}^{′}}{f} & ( 3 )\end{matrix}$$
where I represents the face size at a focal length f, and I′ represents the face size at a focal length f′.

7. The human body and facial animation system of claim 5, wherein the object (O) is a human body comprising a face region and a body region; and the body region is a full body.

8. The human body and facial animation system of claim 7, wherein the face tracking is applied on an inputted 2D image captured with the 3D camera, the extracted face shape is used to drive an avatar face image to act upon the same facial expressions and to be displayed on a screen to be overlapped on any user defined background image.

9. A method of object detection for on-line tracking of human body and facial animation system with 3D camera, comprising the steps of:
detecting and assessing a distance of an object in a depth map from a 3D camera of the human body and facial animation system;
identifying the object as a face and then performing a face tracking procedure, when the object is located near a first predefined distance as measured from the 3D camera and is accompanying a very deep background scene;
identifying the object as a body and then performing a body tracking procedure, when the object is located near a second predefined distance and is recognized to resemble a whole body of a person; and
performing a face and hand gesture detection procedure, when the object is detected to be located in between the first and second predefined distances.

10. The method of claim 9, wherein the 3D camera comprises an image sensor and a depth sensor both having a same fixed focal length, a same image resolution, an equal field of view (FOV) and an aligned image center.

11. The method of claim 9, wherein the 3D camera comprises two images sensors, in which one image sensor having a fixed focal length f′ and the other image sensor having a fixed focal length f.

12. The method of claim 9, wherein the 3D camera is a zoom lens 3D camera, comprising an image sensor having an adjustable focal length and a depth sensor having a fixed focal length.

13. A human body and facial animation system with 3D camera, comprising:
a 3D camera, comprising two images sensors, one image sensor having a fixed focal length f′ and the other image sensor having a fixed focal length f; and
an avatar, displayed on a display device;
wherein the 3D camera is configured to capture images at an extended distance between the 3D camera and a user, the user comprising a face region, and a body region, the face region is captured and extracted by the image sensor having the fixed focal length f′, and the body region is captured and extracted by the image sensor having the fixed focal length f.

14. The human body and facial animation system with 3D camera of claim 13, wherein the avatar comprising a full body of the user and a superimposed face region of an avatar cartoon character.

15. The human body and facial animation system with 3D camera of claim 13, wherein the avatar comprising the full body of the user and a superimposed face region of the user captured at zoom setting at the fixed focal length f′, and the face region comprising higher image details configured for performing animation.
